(19) United States
(12) Patent Application Publication
(10) Pub. No.: US 2014/0099563 A1
(43) Pub. Date: Apr. 10, 2014

(54) FUEL CELL STACK HAVING COOLING MEDIUM LEAKAGE PREVENTING UNIT

(71) Applicant: SAMSUNG ELECTRONICS CO., LTD., Suwon-si (KR)

(72) Inventors: Tae-won SONG, Yongin-si (KR); Kyoung-hwan CHOI, Seoul (KR); Jeong-sik KO, Seongnam-si (KR); Ji-rae KIM, Seoul (KR); Jung-seok YI, Seoul (KR)

(73) Assignee: SAMSUNG ELECTRONICS CO., LTD., Suwon-si (KR)

(21) Appl. No.: 13/795,013

(22) Filed: Mar. 12, 2013

(30) Foreign Application Priority Data
Oct. 10, 2012 (KR) 10-2012-0112662

(51) Int. Cl. H01M 8/04

(52) U.S. Cl. CPC H01M 8/04029
USPC 429/438; 429/434

(57) ABSTRACT

A fuel cell stack includes a plurality of unit cells, a cooling plate and a block plate. Each unit cell includes a cathode electrode and an anode electrode respectively at opposing sides of an electrolyte membrane, and a separator facing each of the cathode electrode and the anode electrode. The cooling plate is between adjacent unit cells a cooling medium flows in the cooling plate. The block plate is between the cooling plate and an adjacent unit cell of the adjacent unit cells. The block plate blocks the cooling medium flowing in the cooling plate from contacting the adjacent unit cell of the adjacent unit cells.

### CROSS-REFERENCE TO RELATED APPLICATIONS

This application claims priority to Korean Patent Application No. 10-2012-0112662, filed on Oct. 10, 2012, and all the benefits accruing therefrom under 35 U.S.C. §119, the disclosure of which is incorporated herein in its entirety by reference.

### BACKGROUND

1. Field

Provided is a fuel cell stack having a unit for preventing leakage of a cooling medium which is used in a cooling plate.

2. Description of the Related Art

A polymer electrolyte membrane fuel cell (“PEMFC”) has a superior output characteristic, a low operating temperature, and a fast start-up and response characteristic, compared to other fuel cells. Also, the PEMFC has a merit of a wide application range, for example, as a power for automobiles, a distribution power for houses and public buildings, and a compact power for electronic devices.

A conventional PEMFC is mainly operated at a relatively low temperature under 100 degrees Celsius (° C.), for example, at about 80° C., due to a problem of drying of a polymer electrolyte membrane within the PEMFC.

### SUMMARY

Provided is a fuel cell stack having a unit for blocking a migration path between a membrane electrode assembly (“MEA”) and a cooling plate in which a cooling oil flows.

Additional aspects will be set forth in part in the description which follows and, in part, will be apparent from the description, or may be learned by practice of the presented embodiments.

Provided is a fuel cell stack which includes a plurality of unit cells, each unit cell including a cathode electrode and an anode electrode disposed at opposing sides of an electrolyte membrane and a separator on each of the cathode electrode and the anode electrode, a cooling plate between adjacent unit cells and through which a cooling medium flows, and a block plate provided between the cooling plate and an adjacent unit cell of the adjacent unit cells, the block plate blocking the cooling medium flowing in the cooling plate from contacting the adjacent unit cell of the adjacent unit cells.

The block plate may include a conductive plate.

The block plate may include any one of a stainless steel plate, a copper plate and a gold-coated stainless plate.

A thickness of the block plate may be about 0.1 millimeter (mm) to about 1.0 mm.

The cooling plate may include a pair of plates facing each other, and a flow path defined in a facing surface of a plate of the pair of plates and through which the cooling medium flows.

The cooling plate may include graphite impregnated with polymer, or a compressed mixture of graphite and polymer.

The separator may contact the block plate and may include a monopolar plate.

The cooling medium may include oil.

The cooling plate may further include a flow path through which the cooling medium flows, and an oil-blocking coating on a surface of the flow path of the cooling plate.

A thickness of the oil-blocking coating may be about 20 micrometers (μm) to about 200 μm.

The cooling plate may include a single plate, and a flow path defined in a surface of the single plate and through which the cooling medium flows.

The cooling plate may further include a cooling medium-blocking coating on a surface of the flow path of the cooling plate.

A thickness of the oil-blocking coating may be about 20 μm to about 200 μm.

Provided is another fuel cell stack which includes a plurality of unit cells, each unit cell including a cathode electrode and an anode electrode disposed at opposing sides of an electrolyte membrane, and a separator on each of the cathode electrode and the anode electrode, and a cooling member including a pair of adjacent separators, a flow path defined in a facing surface of a separator of the pair of separators and through which the cooling medium flows, and a cooling medium-blocking coating on a surface of the flow path.

The fuel cell stack may include a plurality of cooling plates or cooling members arranged at a predetermined interval within the fuel cell stack with respect to the plurality of unit cells.

### BRIEF DESCRIPTION OF THE DRAWINGS

These and/or other aspects will become apparent and more readily appreciated from the following description of the embodiments, taken in conjunction with the accompanying drawings in which:

FIG. 1 is a conceptual diagram showing an embodiment of a cooling method of a fuel cell stack according to the present invention;

FIG. 2 is a perspective view of an embodiment of a fuel cell stack according to the present invention;

FIG. 3 is a partially magnified exploded perspective view of the fuel cell stack of FIG. 2;

FIG. 4 is an exploded cross-sectional view schematically illustrating a portion of the fuel cell stack of FIG. 2;

FIG. 5 is a graph showing the performance of an embodiment of a fuel cell stack according to the present invention and the performance of a conventional fuel cell stack; and

FIG. 6 is an exploded cross-sectional view schematically illustrating a portion of another embodiment of a fuel cell stack according to the present invention.

### DETAILED DESCRIPTION

Reference will now be made in detail to embodiments, examples of which are illustrated in the accompanying drawings, where like reference numerals refer to like elements throughout. In this regard, the present embodiments may have different forms and should not be construed as being limited to the descriptions set forth herein. Accordingly, the embodiments are merely described below, by referring to the figures, to explain aspects of the present description.

It will be understood that when an element or layer is referred to as being “on” or “connected to” another element or layer, the element or layer can be directly on or connected to another element or layer or intervening elements or layers. In contrast, when an element is referred to as being “directly on” or “directly connected to” or “directly coupled to” another element or layer, there are no intervening elements or layers present. As used herein, connected may refer to elements being fluidly, physically and/or electrically connected to each other. As used herein, the term “and/or” includes any and all combinations of one or more of the associated listed items. Expressions such as “at least one of,” when preceding a list of elements, modify the entire list of elements and do not modify the individual elements of the list.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the invention.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used in this specification, specify the presence of stated features, integers, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the invention will be described in detail with reference to the accompanying drawings.

A conventional polymer electrolyte membrane fuel cell (“PEMFC”) which operates at a temperature under about 100 degrees Celsius (° C.) has the following disadvantage. Hydrogen-rich gas that is a typical fuel of the PEMFC is obtained by reforming an organic fuel such as a natural gas or methanol. The hydrogen-rich gas contains not only carbon dioxide but also carbon monoxide as a byproduct. Carbon monoxide tends to poison a catalyst included in a cathode and an anode. The electrochemical activation of a catalyst poisoned by carbon monoxide is considerably degraded and thus the operation efficiency and life of the PEMFC may be considerably reduced. A tendency of poisoning a catalyst by carbon monoxide becomes severe as the operating temperature of the PEMFC is low.

When the operating temperature of the PEMFC is raised over about 120° C., the catalyst poisoning by carbon monoxide may be avoided and the control of the operation temperature may be easy. Accordingly, miniaturization of a reformer and simplification of a cooling apparatus are possible and thus an overall PEMFC power system may be miniaturized.

Air and fuel gas that are externally supplied for electrochemical reaction reach a membrane electrode assembly (“MEA”) via a flow channel of a separator. In general, graphite or a metal material is used for a separator of the PEMFC. A graphite separator is more commonly used for a high temperature PEMFC than a metal separator that may be easily corroded by phosphoric acid.

A fuel cell stack generates electricity and simultaneously heat through an electrochemical reaction. To stably operate a fuel cell stack, the generated heat needs to be removed from the fuel cell stack. For a fuel cell stack generating power of more than several hundreds of watts, the fuel cell stack is cooled by using a cooling medium. The fuel cell stack may be cooled by supplying a cooling medium such as water or oil to a separator or a separate cooling plate.

For a high temperature PEMFC stack, if water is used as a coolant, a high water vapor pressure is generated due to the operating temperature of about 100° C. or higher. For example, at 150° C., a vapor pressure of about 0.5 megapascals (MPa) is generated. Accordingly, a sealing material for high temperature and higher pressure is needed. In contrast, if oil is used as a coolant in the high temperature PEMFC stack, only a pressure corresponding to a pressure loss in a flow path of a cooling plate and a coolant supply and exhaust line in a fuel cell stack is needed. However, a MEA contaminated by the cooling oil may deteriorate performance of a fuel cell including the fuel cell stack.

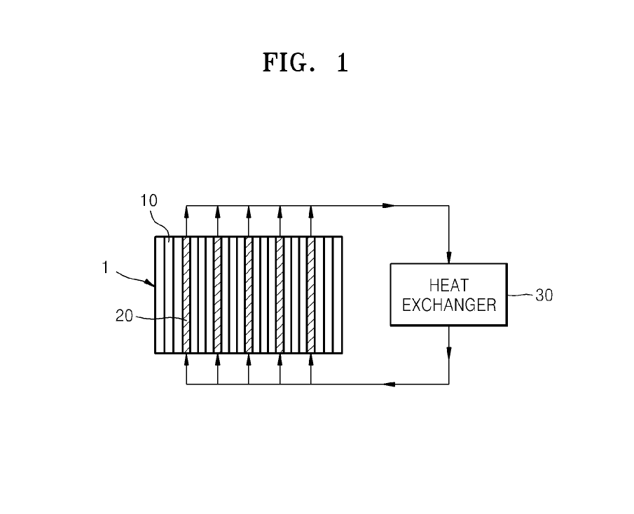

FIG. 1 is a conceptual diagram showing an embodiment of a cooling method of a fuel cell stack according to the present invention. Referring to FIG. 1, a plurality of unit cells 10 is stacked in the fuel cell stack 1 of a high temperature PEMFC. A plurality of cooling plates 20 for cooling the fuel cell stack 1 is arranged at a predetermined interval in the fuel cell stack 1, with respect to the unit cells 10 of the fuel cell stack 1. A flow path is defined in each of the cooling plates 20. A cooling medium passing through the flow path cools the fuel cell stack 1 by taking heat from the fuel cell stack 1. Oil, for example, paraffin oil or silicon oil, may be used as the cooling medium.

The cooling medium may circulate within a closed circuit flow path between the cooling plates 20 and a heat exchanger 30. The cooling medium enters each of the cooling plates 20 and takes heat from the unit cells 10 so that the temperature of the cooling medium increases. The heat is exhausted as the cooling medium passes through the heat exchanger 30. The structure of the cooling plate 20 is described in detail in the following description.

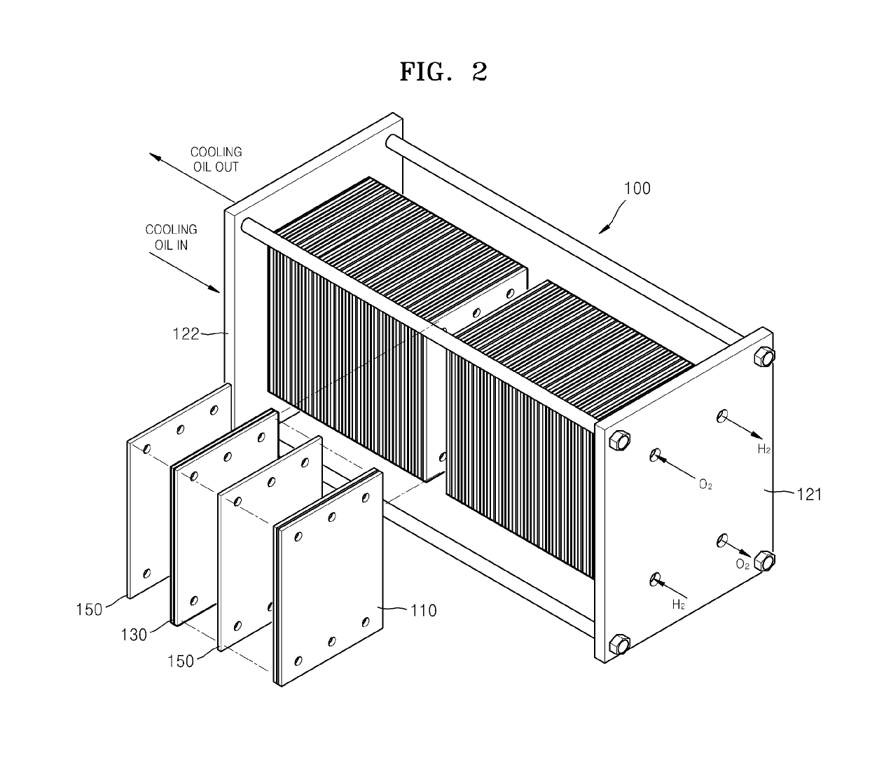

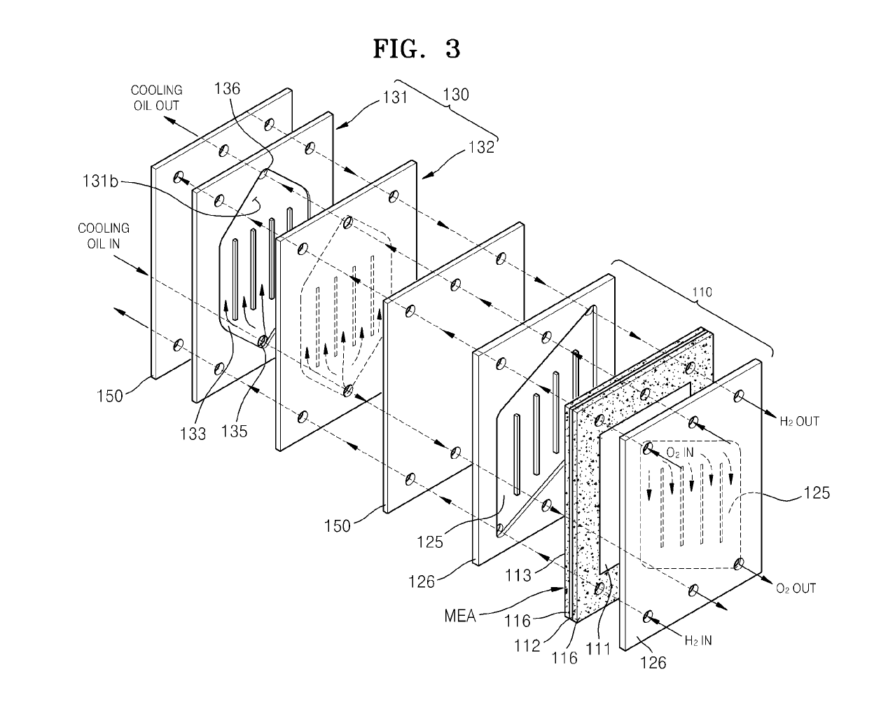

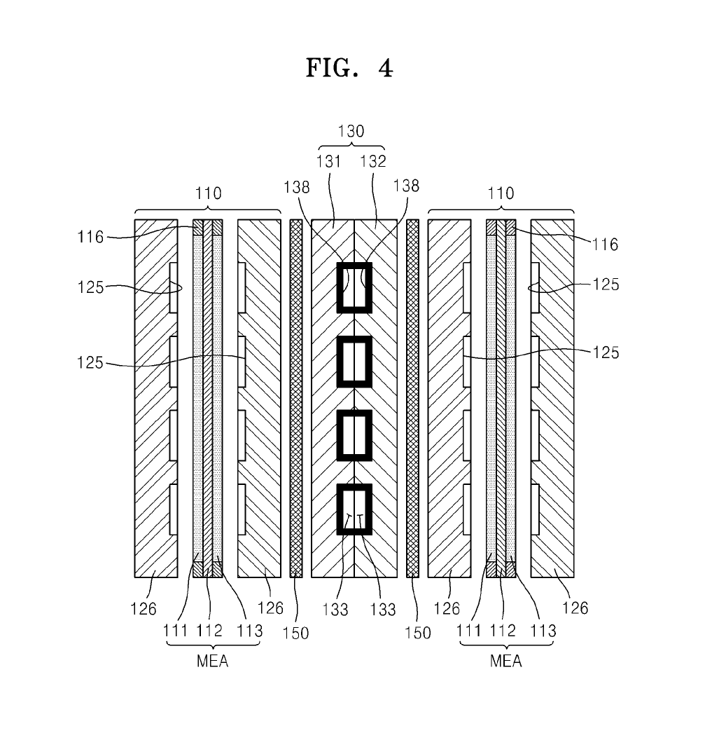

FIG. 2 is a perspective view of an embodiment of a PEMFC stack 100 according to the present invention. FIG. 3 is a partially magnified exploded perspective view of the PEMFC stack 100 of FIG. 2. FIG. 4 is an exploded cross-sectional view schematically illustrating a portion of the PEMFC stack 100 of FIG. 2.

Referring to FIGS. 2 through 4, a plurality of unit cells 110 is stacked in the PEMFC stack 100. Each unit cell 110 includes a MEA, and a separator 126 is provided on opposite sides of MEA.

The MEA includes an electrolyte membrane 112, a cathode electrode 111 and an anode electrode 113. The cathode electrode 111 and the anode electrode 113 are provided at opposite sides of the electrolyte membrane 112. A flow channel 125 through which an oxidizing agent or hydrogen gas is supplied to the cathode electrode 111 and the anode electrode 113 is defined in the separator 126. The MEA may further include a sealing gasket 116 respectively between the cathode and anode electrodes 111 and 113, and the separator 126.

Since not only electricity but also heat is generated in an electrochemical reaction process of a fuel cell, a cooling unit is needed for stable operation of the PEMFC stack 100. A cooling plate 130 is provided in the PEMFC stack 100 for cooling of the PEMFC stack 100. In the illustrated embodiment, one cooling plate 130 through which a cooling medium for heat exchange, for example, cooling oil, passes is provided per several unit cells 110 in the PEMFC stack 100.

The cooling plate 130 may include a first cooling plate 131 and a second plate 132. A flow path 133 is defined in each of facing surfaces of the first and second cooling plates 131 and 132. The flow path 133 may be defined on the first and second cooling plates 131 and 132. When the first and second cooling plates 131 and 132 are disposed facing each other, the flow paths 133 and barriers forming the flow paths 133 may align with each other to collectively form a flow path of the cooling plate 130. An inlet hole 135 into which the cooling medium is introduced and an outlet hole 136 from which the cooling medium is exhausted are defined in each of the first and second cooling plates 131 and 132 and are in fluid communication with the flow path 133 defined in each of facing surfaces of the first and second cooling plates 131 and 132. The cooling medium introduced into the inlet hole 135 passes through the flow path 133 and takes heat from the unit cell 110. After that, the cooling medium is exhausted through the outlet hole 136.

End plates 121 and 122 are provided at opposing ends of the PEMFC stack 100. An oxygen (e.g., air) supply hole (O₂ IN with arrow pointing toward the end plate 121), an oxygen (e.g., air) collection hole (O₂ OUT with arrow pointing away from the end plate 121), a fuel (e.g., hydrogen gas) supply hole (H₂ IN with arrow pointing toward the end plate 121) and a fuel (e.g., hydrogen gas) collection hole (H₂ OUT with arrow pointing away from the end plate 121), may be defined in the end plate 121. As illustrated in FIG. 3, inlet and outlet holes connected with the flow channel 125 of a first separator 126 of a unit cell 110 may be connected to only the oxygen supply hole (O₂ IN) and the oxygen collection hole (O₂ OUT), while inlet and outlet holes connected with the flow channel 125 of a second separator 126 of the same unit cell 110 may be connected to only the hydrogen supply hole (H₂ IN) and the hydrogen collection hole (H₂ OUT),

A cooling medium supply hole indicated by ‘COOLING OIL IN’ and a cooling medium collection hole indicated by ‘COOLING OIL OUT’ which are not visible in the view of FIG. 2, may be defined in the end plate 122. The cooling medium supply and collection holes are respectively in fluid communication with the inlet hole 135 and the outlet hole 136 of the cooling plate 130. The supply holes and the collection holes of the oxygen, fuel and cooling medium may be respectively defined in only one of the end plates 121 and 122. Holes for supplying or exhausting fuel (e.g., air and hydrogen gas) or cooling medium may be defined in each of the elements of the cooling plate 130 and the unit cell 110. The inlet hole 135 and the outlet hole 136 of the cooling plate 130 are not in communication with the oxygen supply hole (O₂ IN), the oxygen collection hole (O₂ OUT), the hydrogen supply hole (H₂ IN) and the hydrogen collection hole (H₂ OUT). Inlet and outlet holes connected with the flow channel 125 of the separators 126 of a unit cell 110 are not in communication with the cooling medium supply hole and the cooling medium collection hole.

A cooling apparatus for cooling down the cooling medium may be provided outside the PEMFC stack 100 and connected to the cooling medium collection hole and the cooling medium supply hole in one of the end plates 121 and 122, such as the end plate 122 illustrated in FIG. 2.

The first and second cooling plates 131 and 132 may include graphite impregnated with polymer, or a compressed mixture of graphite and polymer. The cooling oil may smear into the first and second cooling plates 131 and 132 while passing through the flow path 133. Also, where the cooling plate 130 is adjacent to the unit cell 110, the cooling oil passing through the flow path 133 of the cooling plate 130 may contact the MEA through the separator 126 of the unit cell 110. As a result, the performance of the PEMFC stack 100 may be degraded.

In the embodiment of the PEMFC stack 100 according to the present invention, a blocking member including a block plate 150 which reduces or effectively prevents the cooling oil passing through the flow path 133 of the cooling plate 130 from passing through an adjacent separator 126 may be provided between the second cooling plate 132 and the adjacent separator 126. The block plate 150 may be arranged substantially close to and/or in contact with a surface of each of the first and second cooling plates 131 and 132 in which the flow path 133 is not defined. The block plate 150 may include a conductive material. In embodiments, the block plate 150 may be a stainless steel plate, a copper plate or a gold-coated stainless steel plate, but is not limited thereto or thereby. A thickness of the block plate 150 may be about 0.1 millimeter (mm) to about 1.0 mm. When the block plate 150 is thinner than about 0.1 mm, the block plate 150 may be separated from other elements of the PEMFC stack 100. When the block plate 150 is thicker than about 1.0 mm, the volume of the PEMFC stack 100 increases and thus material costs of the block plate 150 and/or the PEMFC stack 100 may be undesirably increased.

The flow path 133 defined in each of the first and second cooling plates 131 and 132 may have substantially the same shape. Although the flow path 133 has a substantially linear shape in FIG. 3, the present invention is not limited thereto. In an alternative embodiment, for example, the flow path 133 may have a substantially serpentine shape. The separator 126 contacting the block plate 150 may have a relatively large thermal contact surface with the block plate 150 for efficient heat exchange. To this end, the separator 126 may be a monopolar plate having the flow channel 125 defined in one surface only thereof.

An oil-blocking coating 138 for reducing or effectively preventing intrusion of oil may be disposed on a surface of the first and second cooling plates 131 and 132 in which the flow path 133 is defined. The oil-blocking coating 138 may be disposed on inner surfaces of the recessed flow path 133. The oil-blocking coating 138 may include a phenol-based or epoxy-based material. A thickness of the oil-blocking coating 138 taken normal to the surface of the first and second cooling plates 131 and 132 may be about 20 micrometers (μm) to about 200 μm. The oil-blocking coating 138 may be disposed on surfaces of a manifold 131b of FIG. 3, the inlet hole 135 and/or the outlet hole 136. The oil-blocking coating 138 also functions to block a path of oil proceeding toward the block plate 150.

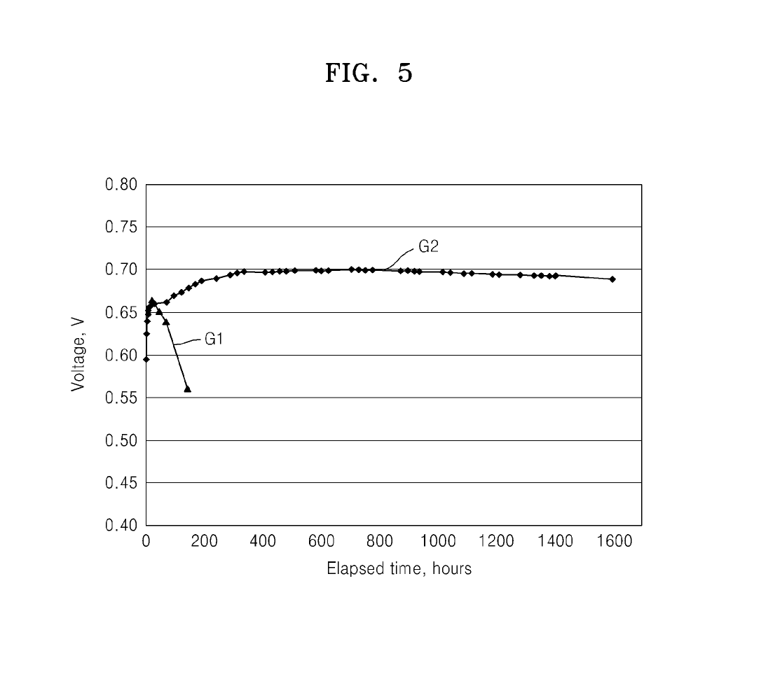

FIG. 5 is a graph showing the performance of an embodiment of a fuel cell stack according to the present invention and the performance of a conventional fuel cell stack. The embodiment of the fuel cell stack according to the present invention includes a fuel cell having 16 unit cells. A cooling plate is provided at each of the second, sixth, tenth and twelfth unit cells. A gold-coated stainless steel plate having a thickness of about 0.2 mm is used as a block plate. An oil-blocking coating is not disposed on a flow path of the cooling plate. In the graph of FIG. 5, the vertical axis indicates an average voltage in volts (V) of each unit cell of a fuel cell and the horizontal axis denotes elapsed time in hours.

In the present comparison test, an embodiment of a fuel cell stack where the block plate 150 is removed is used as the conventional fuel cell stack.

Referring to FIG. 5, a first graph G1 indicating the performance of the conventional fuel cell stack shows that an output voltage drastically decreases after about 40 hours pass. The first graph G1 also shows that the output voltage is reduced lower than about 0.6 V before about 200 hours pass. This is because the cooling oil may intrude into the MEA from the cooling plate through the separator thereby blocking the supply of oxygen and hydrogen into the MEA.

In contrast, a second graph G2 indicating the performance of the embodiment of the fuel cell stack including the block pate according to the present invention shows that the output voltage is maintained constant at about 0.7 V until almost about 1600 hours pass. This is because although the cooling oil may intrude into the cooling plate, further intrusion of the cooling oil into the separator is reduced or effectively prevented by the block plate and thus the cooling oil fails to block the supply of oxygen and hydrogen.

Although in the embodiment of the present invention, the cooling plate 130 includes both of the first and second cooling plates 131 and 132 and a flow path 133 is defined in each of the first and second cooling plates 131 and 132, the present invention is not limited thereto. In an alternative embodiment, for example, a flow path may be defined in only one of the first and second cooling plates 131 and 132 and no flow path is defined in the other of the first and second cooling plates 131 and 132. Alternatively, the cooling plate 130 may include only one of the first and second cooling plates 131 and 132, and a flow path is defined in the only one of the first and second cooling plates 131 and 132. In an embodiment, the flow path may be completely contained within an inside of the only one cooling plate, or the flow path may be recessed from an outer surface of the only one cooling plate and opened to face an adjacent member of the PEMFC stack 100 such as the blocking plate 150. The oil-blocking coating 138 may be provided on the flow path of the only one cooling plate.

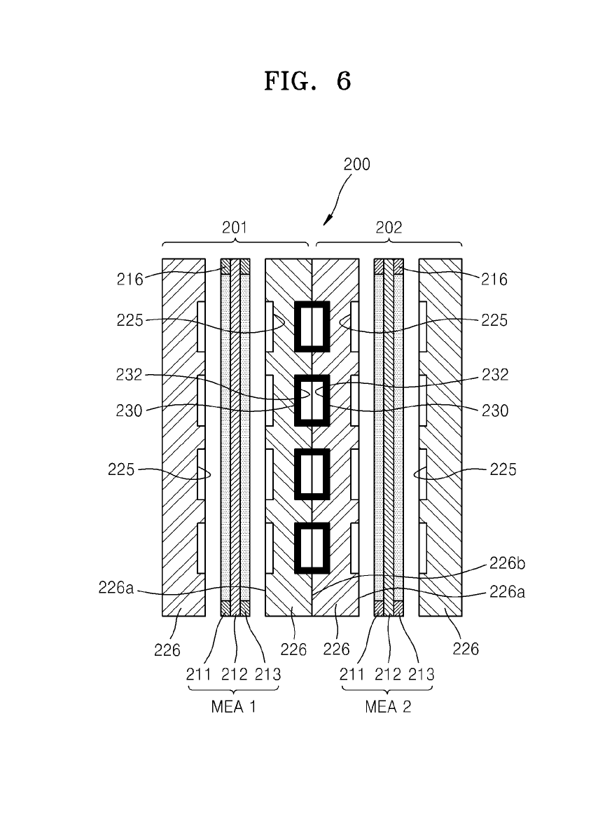

FIG. 6 is an exploded cross-sectional view schematically illustrating another embodiment of a portion of a PEMFC stack according to the present invention. Like reference numerals are used for like elements in the descriptions of the above and present embodiments and thus the same descriptions are omitted herein.

Referring to FIG. 6, a PEMFC stack 200 includes a plurality of unit cells. FIG. 6 illustrates two unit cells 201 and 202, each having a cooling apparatus. One cooling apparatus may be provided for every 3 to 7 unit cells. Each of the unit cells 201 and 202 includes a first MEA (MEA1) or a second MEA (MEA2). The first MEA includes an electrolyte membrane 212, and a cathode electrode 211 and an anode electrode 213 which are arranged at opposing sides of the electrolyte membrane 212. A separator 226 is arranged at each of opposing sides of the first MEA1. A flow channel 225 for supplying hydrogen or oxygen is defined in a surface of the separator 226 facing the first MEA.

The second MEA2 includes the electrolyte membrane 212, and the cathode electrode 211 and the anode electrode 213 which are arranged at opposing sides of the electrolyte membrane 212. The separator 226 is arranged at each of opposing sides of the second MEA2. The flow channel 225 for supplying hydrogen or oxygen is defined in a surface of the separator 226 facing the second MEA.

The cooling apparatus includes the two separators 226 between the first and second MEAs. Each of the two separators 226 between the first and second MEAs has a first surface 226a facing corresponding MEA1 or MEA2. Second surfaces 226b of the two separators 226 between the first and second MEAs face each other and may contact each other. The flow channel 225 is defined in the first surface 226a of each of the two separators 226 between the first and second MEAs. A flow path 230 through which cooling oil flows is defined in the second surface 226b of each of the two separators 226 between the first and second MEAs. A blocking member including an oil-blocking coating 232 is disposed on a surface of the flow path 230 to reduce or effectively prevent intrusion of the cooling oil into the two separators 226 between the first and second MEAs. The oil-blocking coating 232 may include phenol-based or epoxy-based material. A thickness of the oil-blocking coating 232 may be about 20 μm to about 200 μm.

A sealing gasket 216 may be provided between the separators 226 of the unit cells 201 and 202, and each of the cathode electrode 211 and the anode electrode 213 of the unit cells 201 and 202, respectively.

Although FIG. 6 illustrates that the cooling apparatus includes the flow path 230 through which cooling oil flows defined in the second surfaces 226b of the separators 226 between the first and second MEAs and facing each other, the present invention is not limited thereto. In an alternative embodiment, for example, the flow path 230 of the cooling apparatus may be defined in the second surface 226b of only one of the separators 226 between the first and second MEAs and facing each other and the oil-blocking coating 232 may be disposed on the surface of the flow path 230.

According to one or more embodiment of the present invention, in a PEMFC stack using oil as a cooling medium, since a cooling medium blocking member for reducing or effectively preventing intrusion of cooling oil flowing in a cooling apparatus to an MEA through separator is provided, degradation of performance of the PEMFC stack may be reduced or effectively prevented. The cooling medium blocking member may include a block plate and/or a coating within a flow path of the cooling apparatus.

Also, when the PEMFC includes the block plate, an oil-blocking coating may be further disposed on a surface of a groove of the flow path the cooling apparatus, leakage of the cooling oil may be further reduced or effectively prevented.

It should be understood that the embodiments described herein should be considered in a descriptive sense only and not for purposes of limitation. Descriptions of features or aspects within each embodiment should typically be considered as available for other similar features or aspects in other embodiments.

What is claimed is:

1. A fuel cell stack comprising:
a plurality of unit cells, each unit cell comprising:
an electrolyte membrane;
a cathode electrode and an anode electrode respectively at opposing sides of the electrolyte membrane; and
a separator facing each of the cathode electrode and the anode electrode;
a cooling plate between adjacent unit cells and in which a cooling medium flows; and
a block plate between the cooling plate and an adjacent unit cell of the adjacent unit cells, wherein the block plate blocks the cooling medium which flows in the cooling plate from contacting the adjacent unit cell of the adjacent unit cells.

2. The fuel cell stack of claim 1, wherein the block plate comprises a conductive plate.

3. The fuel cell stack of claim 2, wherein the block plate comprises one of a stainless steel plate, a copper plate and a gold-coated stainless plate.

4. The fuel cell stack of claim 3, wherein a thickness of the block plate is about 0.1 millimeter to about 1.0 millimeter.

5. The fuel cell stack of claim 1, wherein the cooling plate comprises:
a pair of plates facing each other, and
a flow path defined in a facing surface of a plate of the pair of plates, and through which the cooling medium flows.

6. The fuel cell stack of claim 1, wherein the cooling plate comprises graphite impregnated with polymer, or a compressed mixture of graphite and polymer.

7. The fuel cell stack of claim 1, wherein the separator contacts the block plate and comprises a monopolar plate.

8. The fuel cell stack of claim 1, wherein the cooling medium comprises oil.

9. The fuel cell stack of claim 8, wherein the cooling plate comprises:
a flow path through which the cooling medium flows; and
an oil-blocking coating on a surface of the flow path.

10. The fuel cell stack of claim 9, wherein a thickness of the oil-blocking coating is about 20 micrometers to about 200 micrometers.

11. The fuel cell stack of claim 1, wherein the cooling plate comprises:
a single plate, and
a flow path defined in the single plate and through which the cooling medium flows.

12. The fuel cell stack of claim 11, wherein the cooling plate further comprises a cooling medium-blocking coating on a surface of the flow path.

13. The fuel cell stack of claim 12, wherein a thickness of the cooling medium-blocking coating is about 20 micrometers to about 200 micrometers.

14. A fuel cell stack comprising:
a plurality of unit cells, each unit cell comprising:
an electrolyte membrane;
a cathode electrode and an anode electrode respectively at opposing sides of the electrolyte membrane; and
a separator facing each of the cathode electrode and the anode electrode; and
a cooling member comprising:
a pair of facing separators,
a flow path defined in a facing surface of a separator of the pair of separators, and through which a cooling medium flows, and
a cooling medium-blocking coating on a surface of the flow path.

15. The fuel cell stack of claim 14, wherein the cooling medium comprises oil.

16. The fuel cell stack of claim 15, wherein a thickness of the cooling medium-blocking coating is about 20 micrometers to about 200 micrometers.

17. The fuel cell stack of claim 1, further comprising a plurality of cooling plates arranged at a predetermined interval within the fuel cell stack with respect to the plurality of unit cells.

18. The fuel cell stack of claim 14, further comprising a plurality of cooling members arranged at a predetermined interval within the fuel cell stack with respect to the plurality of unit cells.

19. A fuel cell stack comprising:
a plurality of unit cells, each unit cell comprising:
an electrolyte membrane;
a cathode electrode and an anode electrode respectively at opposing sides of the electrolyte membrane; and
a separator facing each of the cathode electrode and the anode electrode;
a cooling member between adjacent unit cells and in which a cooling medium flows; and
a blocking member between the cooling member and the separator of the each unit cell, wherein the blocking member blocks the cooling medium which flows in the cooling member from contacting the separator of the each unit cell

20. The fuel cell stack of claim 14, wherein
the cooling member comprises a flow path defined in a surface of the separator of the each unit cell and through which the cooling medium flows, and
the blocking member comprises a cooling medium-blocking coating on a surface of the flow path.
